(19) United States
(12) Patent Application Publication
(10) Pub. No.: US 2022/0245395 A1
(43) Pub. Date: Aug. 4, 2022

(54) COMPUTER-READABLE RECORDING MEDIUM STORING DETERMINATION PROGRAM, DETERMINATION METHOD, AND DETERMINATION DEVICE

(71) Applicant: FUJITSU LIMITED, Kawasaki-shi (JP)

(72) Inventors: Akihito Yoshii, Setagaya (JP); Kenichi KOBAYASHI, Kawasaki (JP)

(73) Assignee: FUJITSU LIMITED, Kawasaki-shi (JP)

(21) Appl. No.: 17/517,694

(22) Filed: Nov. 3, 2021

(30) Foreign Application Priority Data
Feb. 2, 2021 (JP) 2021-015337

(51) Int. Cl. G06K 9/62

(52) U.S. Cl. CPC G06K 9/6215; G06K 9/6256; G06K 9/6262

(57) ABSTRACT

A non-transitory computer-readable recording medium stores a determination program for causing a computer to execute processing including: specifying a difference between feature amounts of a plurality of first images that is captured in chronological order or of which the difference between the feature amounts is equal to or less than a threshold; referring to information in which the difference is associated with a data augmentation processing type and determining one or a plurality of data augmentation processing types used for processing of generating machine learning data on the basis of the specified difference between the feature amounts; and outputting a result of the determination processing.

### CROSS-REFERENCE TO RELATED APPLICATION

This application is based upon and claims the benefit of priority of the prior Japanese Patent Application No. 2021-15337, filed on Feb. 2, 2021, the entire contents of which are incorporated herein by reference.

### FIELD

The embodiment discussed herein is related to a determination technology.

### BACKGROUND

In a software system using machine learning such as deep learning, an operation result depends on properties of input data, and it is difficult to define a correct answer and test the system. Furthermore, a phenomenon is known in which a result output by the system largely fluctuates by applying a change that humans can hardly recognize to input data to a machine learning model such as an image. Therefore, it is needed to ensure robustness so that the results are not affected by the change in the data to which the same correct answer label is added. There is a Data augmentation technique for increasing the types by adding a change (perturbation) to the input data in order to improve the robustness.

U.S. Patent Application Publication No. 2018/0108162, Japanese Laid-open Patent Publication No. 2018-055516, Japanese Laid-open Patent Publication No. 2020-112967, and Japanese Laid-open Patent Publication No. 2019-153057 are disclosed as related art.

### SUMMARY

According to an aspect of the embodiments, a non-transitory computer-readable recording medium stores a determination program for causing a computer to execute processing including: specifying a difference between feature amounts of a plurality of first images that is captured in chronological order or of which the difference between the feature amounts is equal to or less than a threshold; referring to information in which the difference is associated with a data augmentation processing type and determining one or a plurality of data augmentation processing types used for processing of generating machine learning data on the basis of the specified difference between the feature amounts; and outputting a result of the determination processing.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a traditional Data augmentation technique;

FIG. 2 is a diagram illustrating a configuration example of a determination device;

FIG. 3 is a diagram illustrating an example of perturbation operation estimation processing;

FIG. 4 is a diagram illustrating another example of the perturbation operation estimation processing;

FIG. 5 is a flowchart illustrating a flow or the entire perturbation operation estimation processing;

FIG. 6 is a flowchart illustrating an example of a flow of image selection processing;

FIG. 7 is a flowchart illustrating another example of the flow of the image selection processing;

FIG. 8 is a flowchart illustrating a flow of the perturbation operation estimation processing;

FIG. 9 is a flowchart illustrating a flow of format shaping processing;

FIG. 10 is a diagram illustrating an example of machine learning data generation; and

FIG. 11 is a diagram for explaining a hardware configuration example.

### DESCRIPTION OF EMBODIMENTS

For example, with the traditional Data augmentation technique, a developer selects a type of a perturbation operation in advance. Therefore, reality and completeness of input data depend on the selected type of the perturbation operation.

In one aspect, an object is to provide a determination program, a determination method, and a determination device that further improve robustness of a machine learning model.

Hereinafter, examples of a determination program, a determination method, and a determination device according to the present embodiment will be described in detail with reference to the drawings. Note that the present embodiment is not limited by the examples. Furthermore, the examples can be appropriately combined within a range without inconsistency.

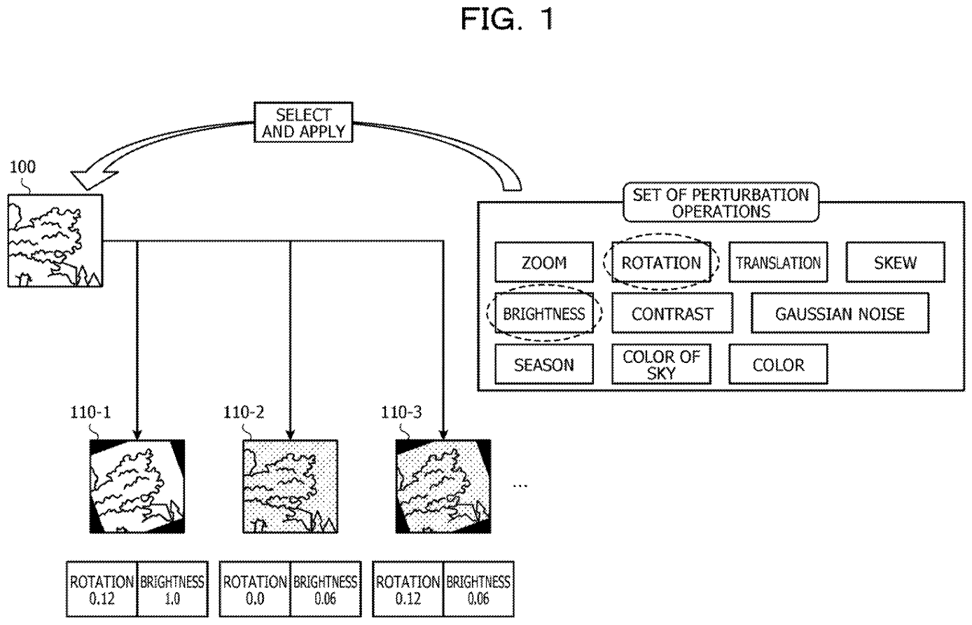

First, the traditional Data augmentation technique will be described. FIG. 1 is a diagram illustrating an example of the traditional Data augmentation technique. As illustrated in FIG. 1, with the traditional Data augmentation technique, a perturbation operation is selected and applied to an original image 100, and images 110-1, 110-2, 110-3, . . . (collectively referred to as “image 110”) are generated as input data to a machine learning model.

At this time, all perturbation operations are not applied to the original image 100, and the perturbation operation and its parameter range are selected by a developer or the like on the basis of specific criteria. For example, in FIG. 1, rotation and brightness are selected as perturbation operations, and parameter ranges of the rotation and the brightness are selected. Operations of the rotation and the brightness are applied to the original image 100 while changing each parameter, and the image 110 is generated.

In this way, it is possible to generate the image 110 and increase the input data to the machine learning model. However, the selected and applied perturbation operation may be an operation that have little effect on the input data to the machine learning model or does not include necessary operations. More specifically, for example, in a case where the selected and applied perturbation operation does not exist in an application destination of the machine learning model, if all parameters of all perturbation operations are set as targets, a search space in machine learning may increase more than necessary. Furthermore, when a perturbation operation other than the selected and applied perturbation operation occurs in the application destination of the machine learning model, search in the machine learning may be insufficiently performed.

Therefore, in the present embodiment, a determination device estimates and selects a perturbation operation with conditions close to an application domain for an image used for input data to a machine learning model and further improves accuracy and robustness of the machine learning model.

[Functional Configuration of Determination Device 10]

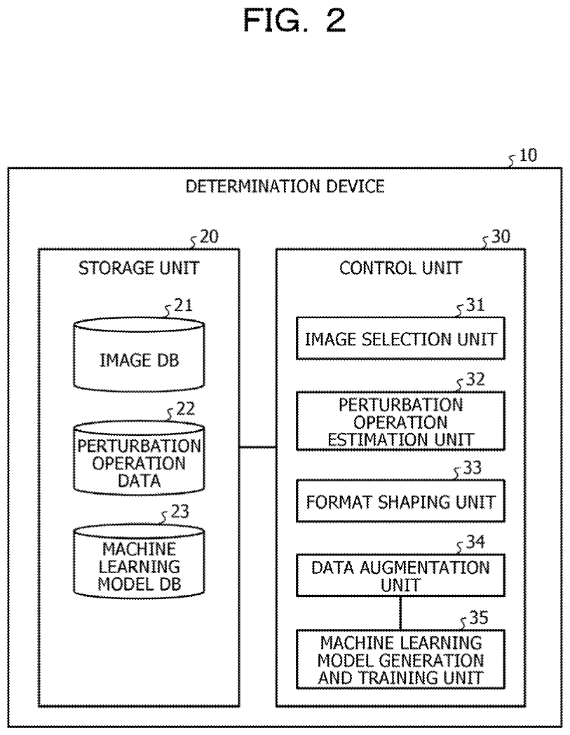

Next, a functional configuration of the determination device 10 illustrated in FIG. 1 will be described. FIG. 2 is a diagram illustrating a configuration example of a determination device. The determination device 10 is, for example, an information processing device such as a desktop personal computer (PC) or a server computer. Note that FIG. 1 illustrates the determination device 10 as one computer. However, the determination device 10 may be a distributed computing system including a plurality of computers. Furthermore, as illustrated in FIG. 2, the determination device 10 includes a storage unit 20 and a control unit 30.

The storage unit 20 is an example of a storage device that stores various types of data and a program executed by the control unit 30 and is, for example, a memory, a hard disk, or the like. The storage unit 20 includes an image database (DB) 21, perturbation operation data 22, a machine learning model DB 23, or the like.

The image DB 21 stores an original image used to estimate a perturbation operation, for example, a set of still images or a moving image that are captured in advance in a practical environment, an environment close to the practical environment, or the like. The practical environment is, for example, a place near a stage in a conference hall, and the environment close to the practical environment is, for example, a place near a platform in a classroom. Furthermore, the still image or the moving image may be captured in an environment in which the perturbation operation that may occur in the practical environment can be reproduced, for example, an environment in which changes in vibration and illumination can be reproduced indoors. Note that the conference hall, the classroom, indoors, and the like are examples of the environment, and the practical environment or the like naturally includes outdoors. Furthermore, although the original image is exemplified as the image DB 21, the image DB 21 may include an image obtained by applying a perturbation operation to the original image.

The perturbation operation data 22 stores a type of perturbation operation that may occur, for example, types of the perturbation operations indicated as a set of the perturbation operations in FIG. 1. Note that the set of perturbation operations illustrated in FIG. 1 is merely an example, and the perturbation operation is not limited to the perturbation operations illustrated in FIG. 1 and may include, for example, machine learning algorithms such as affine transformation, a special effect filter, image conversion by a neural network (NN), generative adversarial networks (GAN), or the like. The perturbation operation data 22 may store a range of parameters of perturbation operations that may occur.

The machine learning model DB 23 stores, for example, a parameter used to construct a machine learning model generated through machine learning that uses an image generated using the Data augmentation technique as a feature amount and a person or an object included in the image as a correct answer label. Furthermore, the machine learning model DB 23 stores training data for the machine learning model. In the present embodiment, training data that further improves robustness of the machine learning model is generated.

Note that the data described above stored in the storage unit 20 is merely an example, and the storage unit 20 can store various types of data other than the data described above.

The control unit 30 is a processing unit that controls the entire determination device 10 and is, for example, a processor or the like. The control unit 30 includes an image selection unit 31, a perturbation operation estimation unit 32, a format shaping unit 33, a Data augmentation unit 34, and a machine learning model generation and training unit 35. Note that each processing unit is an example of an electronic circuit included in a processor and an example of a process performed by the processor.

The image selection unit 31 compares similarities between still images captured in the practical environment or the like and selects an image that conforms with similarity criteria. Furthermore, the image selection unit 31 selects an image corresponding to a frame that is temporally close from among the moving images captured in the practical environment or the like, for example, images captured in chronological order.

The perturbation operation estimation unit 32 specifies a difference between feature amounts of the respective plural images selected by the image selection unit 31. Furthermore, the perturbation operation estimation unit 32 determines one or a plurality of data augmentation processing types under conditions close to an application domain, for example, the type of perturbation operation on the basis of the specified difference between the feature amounts. Furthermore, the perturbation operation estimation unit 32 aggregates parameters in the respective images for each type of the determined perturbation operation and derives a range of the parameter of the perturbation operation. In this way, the perturbation operation estimation unit 32 estimates a perturbation operation that may occur.

The format shaping unit 33 shapes the type of the perturbation operation estimated by the perturbation operation estimation unit 32 and a range of its parameter in a format that can be used for post-processing such as Data augmentation processing and outputs the format.

The Data augmentation unit 34 applies the perturbation operation on an image using the type of the perturbation operation and the range of the parameter shaped by the format shaping unit 33 and generates input data to the machine learning model.

The machine learning model generation and training unit 35 sets the image, to which the perturbation operation has been applied, generated by the Data augmentation unit 34 as a feature amount and generates and trains the machine learning model using a person and an object included in the image as a correct answer label.

[Details of Functions]

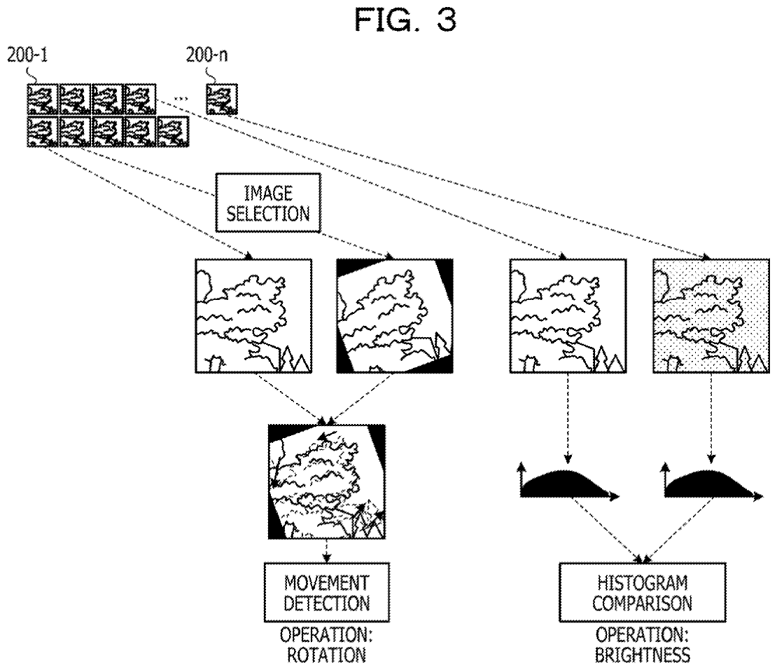

Next, a perturbation operation estimation method mainly performed by the determination device 10 according to the present embodiment will be described in detail. FIG. 3 is a diagram illustrating an example of the perturbation operation estimation processing. In the example illustrated in FIG. 3, the determination device 10 may estimate a perturbation operation that may occur in an application destination of the machine learning model from among a plurality of images selected from among still images 200-1 to 200-n (n is any integer. Hereinafter, collectively referred to as “still image 200”) captured in the practical environment or the like.

In the image selection from the still image 200, for example, similarities between the still images 200 are compared, and a still image 200 that conforms with the similarity criteria is selected. Note that it is not necessary for all the selected still images 200 to conform with the similarity criteria, for example, as illustrated in FIG. 3, it is sufficient that each pair of the still images 200 of which the difference between the feature amounts is specified be conform to the similarity criteria.

Then, as illustrated in FIG. 3, the determination device 10 estimates the perturbation operation that may occur from the difference between the feature amounts of the plurality of selected still images 200. FIG. 3 is an example in which each of two types of perturbation operations including rotation and brightness is estimated from a movement of the selected still image 200 and a difference of a histogram. The number of types of perturbation operations to be estimated is not naturally limited to the two types. Furthermore, the difference between the feature amounts of the images is specified using existing techniques such as analysis of an optical flow or a histogram corresponding to the perturbation operation or more complicated image registration for each perturbation operation.

Moreover, for example, the determination device 10 aggregates the parameter of the perturbation operation for each of the selected still images 200 and estimates the range of the parameter that may occur. Then, for example, by applying the estimated perturbation operation to any one of the still images 200 while changing the parameter within the estimated range of the parameter, the determination device 10 generates the input data to the machine learning model.

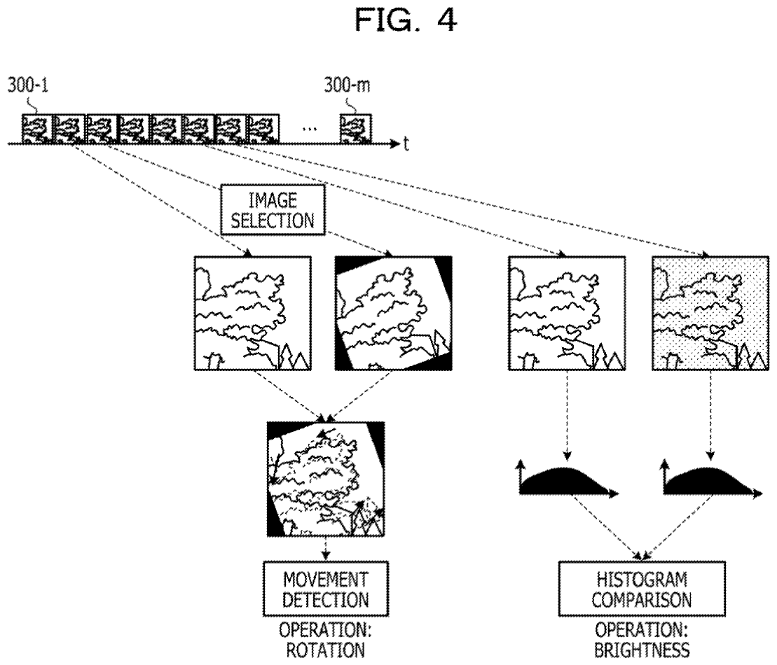

Furthermore, in FIG. 3, an example is illustrated in which an image is selected from among the still images 200. However, the determination device 10 can select an image from a moving image. FIG. 4 is a diagram illustrating another example of the perturbation operation estimation processing. In the example in FIG. 4, the determination device 10 estimates a perturbation operation that may occur from among a plurality of images selected from a moving image captured in the practical environment or the like, for example, images 300-1 to 300-m (m is any integer. Hereinafter, collectively referred to as “image 300”) captured in chronological order.

In the image selection from the images 300, for example, an image corresponding to a frame that is temporally close in the images 300 is selected. Note that it is not necessary to correspond to the frame that is close to the selected image 300, and for example, as illustrated in FIG. 4, it is sufficient to correspond to frames of which the images 300 in each pair, of which a difference between feature amounts is specified, are close to each other. Note that the estimation of the perturbation operation after the image selection in FIG. 4 is similar to that in FIG. 3.

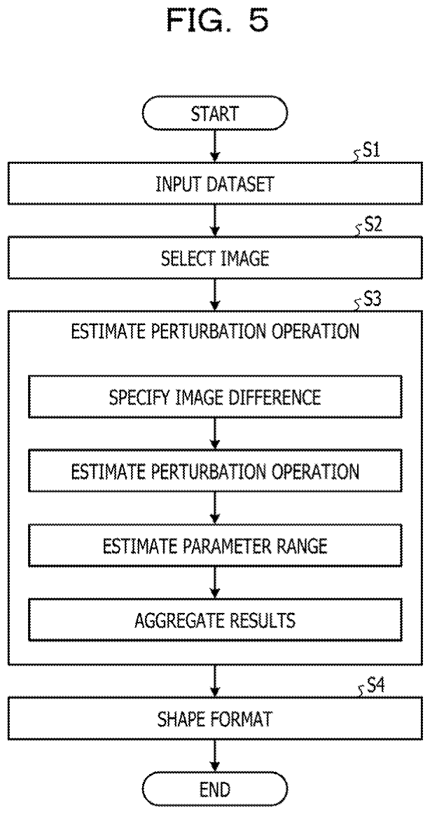

Next, the perturbation operation estimation processing will be described in detail with reference to the flowcharts illustrated in FIGS. 5 to 9. FIG. 5 is a flowchart illustrating a flow of the entire perturbation operation estimation processing.

First, as illustrated in FIG. 5, a dataset is input to the determination device 10 (step S1). The dataset input here is the plurality of still images 200 or a moving image, for example, the plurality of images 300 that has been captured in advance in the practical environment, an environment close to the practical environment, or the like. Furthermore, the dataset is input, for example, by reading the still image 200 or the image 300 stored in the image DB 21 or the like by executing a program for executing the perturbation operation estimation processing by a developer.

Next, the determination device 10 selects an image from among the still images 200 or the images 300 input in step S1 as described with reference to FIGS. 3 and 4 (step S2).

Next, the determination device 10 estimates the type of the perturbation operation that may occur and the range of the parameter from the difference between the feature amounts of the still images 200 or the images 300 selected in step S2 (step S3). Details of step S3 will be described later.

Next, the determination device 10 shapes the type of the perturbation operation and the range of the parameter estimated in step S3 into a format that can be used for the post-processing such as the Data augmentation processing (step S4). After step S4 is executed, the perturbation operation estimation processing illustrated in FIG. 5 ends.

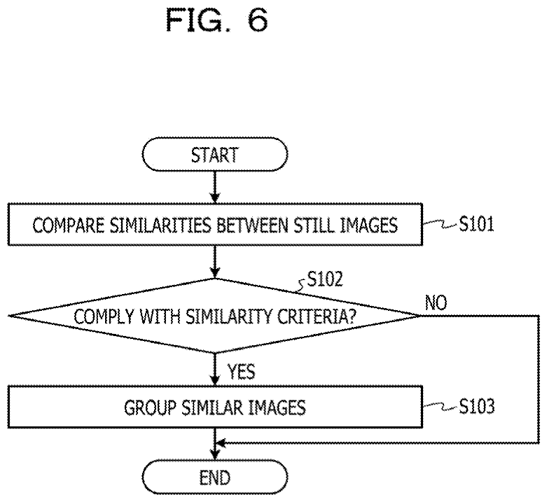

Next, image selection processing in step S2 in the entire processing illustrated in FIG. 5 will be described with reference to a more detailed flowchart. FIG. 6 is a flowchart illustrating an example of a flow of the image selection processing. FIG. 6 illustrates image selection processing in a case where the plurality of still images 200 is input in step S1.

First, as illustrated in FIG. 6, the determination device 10 compares similarities between the plurality of still images 200 input in step S1 (step S101). Note that the comparison between the similarities is performed for each pair of the plurality of still images 200.

Next, the determination device 10 determines whether or not the similarity of each pair of the plurality of still images 200 complies with predetermined similarity criteria (step S102). Here, the predetermined similarity criteria are, for example, criteria based on a threshold condition or a search result of a solution for an optimization problem using a calculation result of a correlation value, an information amount, or the like according to a pixel value and the like in a window region. Alternatively, the predetermined similarity criteria are criteria based on the similarity between the detected features, such as conspicuous points, lines, or regions, in an image. However, the predetermined similarity criteria are not limited to these criteria.

In a case where the similarities of all the pairs of the plurality of still images 200 do not conform with the predetermined similarity criteria (step S102: No), the image selection processing illustrated in FIG. 6 ends. On the other hand, in a case where the similarity of any one pair of the plurality of still images 200 conforms with the predetermined similarity criteria (step S102: Yes), the determination device 10 groups the similar still images 200 into pairs (step S103). After step S103 is executed, the image selection processing illustrated in FIG. 6 ends.

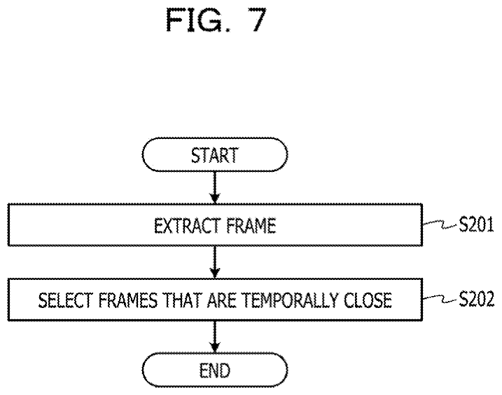

The image selection processing in a case where the plurality of still images 200 is input in step S1 has been described with reference to FIG. 6. Next, image selection processing in a case where a moving image is input in step S1 will be described. FIG. 7 is a flowchart illustrating another example of the flow of the image selection processing.

First, as illustrated in FIG. 7, the determination device 10 extracts each frame from the moving image input in step S1 (step S201).

Next, the determination device 10 selects frames that are temporally close from among the frames extracted in step S201 (step S202). In the frame selection in step S202, for example, a pair of frames temporally close to each other may be selected from among the frames in the entire moving image. However, frames may be comprehensively selected such as acquiring pairs from the beginning, middle, and end of the moving image. After the execution of step S202, the image selection processing illustrated in FIG. 7 ends. According to this processing, images 300 corresponding to the frames selected in step S202 are acquired from the moving image input in step S1.

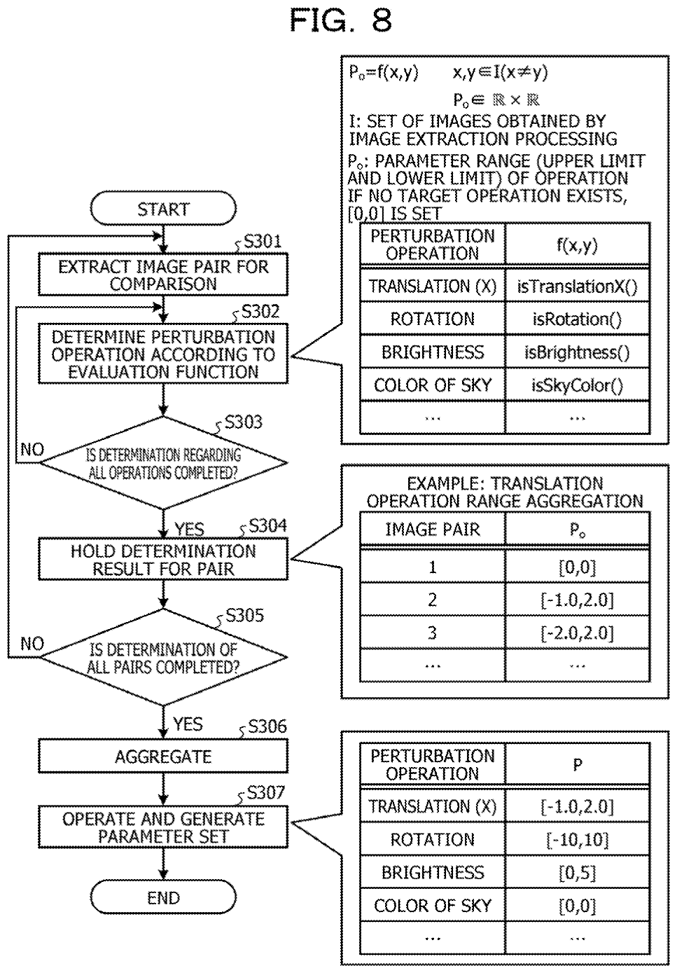

Next, the perturbation operation estimation processing in step S3 in the entire processing illustrated in FIG. 5 will be described with reference to a detailed flowchart. FIG. 8 is a flowchart illustrating a flow of the perturbation operation estimation processing.

First, as illustrated in FIG. 8, the determination device 10 extracts a pair of images for comparison (step S301). The extracted pair is a pair of the still images 200 grouped in step S102 or a pair of the images 300 corresponding to the pair of frames selected in step S202.

Next, the determination device 10 determines a perturbation operation, for example, using an evaluation function from the pair of images extracted in step S301 (step S302). As illustrated in FIG. 8, an evaluation function f (x, y) is a function that outputs a parameter range P₀ of a target perturbation operation from a difference between feature amounts of the pair of extracted images for each perturbation operation using an existing technique such as an optical flow, a histogram, image registration, or the like.

In a case where determination of all perturbation operations is not completed for the pair of extracted images (step S303: No), the procedure returns to step S302, and the determination device 10 performs determination regarding remaining perturbation operations. Note that, for example, a perturbation operation that obviously does not occur in the pair of extracted images such as a sky color with respect to an image of indoors may be excluded from all the perturbation operations.

On the other hand, in a case where the determination regarding all the perturbation operations is completed for the pair of extracted images (step S303: Yes), the determination device 10 holds a determination result for the pair of extracted images (step S304). To hold the determination result, for example, as illustrated in FIG. 8, the parameter range P₀ is held for each pair of images and for each type of perturbation operations. Note that a unit of each parameter to be held is preset for each perturbation operation.

In a case where the determination regarding the perturbation operation is not completed for all the pairs of extracted images (step S305: No), the procedure returns to step S302, and the determination device 10 determines perturbation operations for remaining pairs of images.

On the other hand, in a case where the determination regarding the perturbation operation is completed for all the pairs of extracted images (step S305: Yes), the determination device 10 aggregates the parameter range P₀ that is held for each type of perturbation operations (step S306). More specifically, for example, the determination device 10 (1) remains a value included in an average±a standard deviation or (2) calculates the average and the maximum and minimum values for each of an upper limit and a lower limit of the parameter range P₀ for all the pairs of extracted images for each type of perturbation operations. Note that, the aggregation method includes, for example, statistical processing or the like.

Then, as illustrated in FIG. 8, the determination device 10 generates a set of parameter ranges P aggregated for each perturbation operation (step S307). After step S307 is executed, the perturbation operation estimation processing illustrated in FIG. 8 ends.

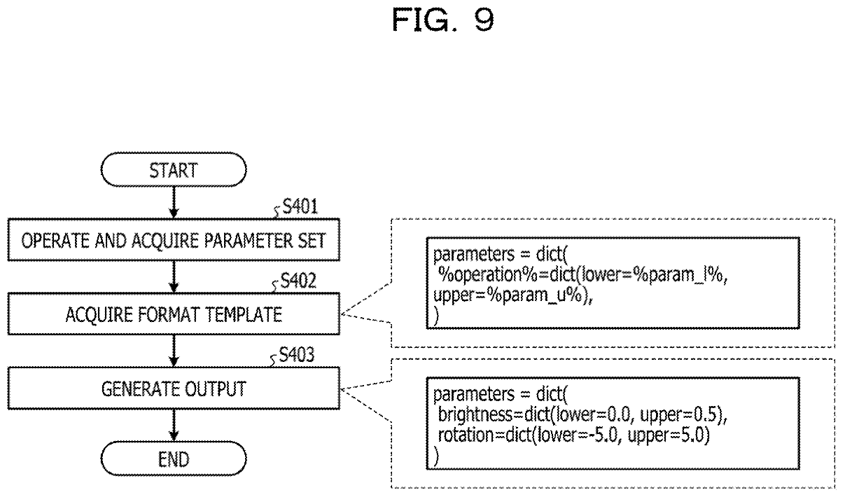

Next, the format shaping processing in step S4 in the entire processing illustrated in FIG. 5 will be described with reference to a detailed flowchart. FIG. 9 is a flowchart illustrating a flow of the format shaping processing.

First, as illustrated in FIG. 9, the determination device 10 acquires the set of the parameter ranges P aggregated for each perturbation operation (step S401). The set is generated in step S307 in the perturbation operation estimation processing illustrated in FIG. 8.

Next, the determination device 10 acquires a format template as illustrated in FIG. 9 so that the parameter range for each perturbation operation acquired in step S401 can be used for post-processing such as Data augmentation processing (step S402). The format template is created by a developer in advance and set to a text generation library.

Next, the determination device 10 shapes the parameter range for each perturbation operation acquired in step S401 using the template acquired in step S402 and outputs the parameter range (step S403). More specifically, for example, as illustrated in FIG. 9, a character string enclosed by % in the format template is replaced with a character string indicating the type of the perturbation operation or the upper limit and the lower limit of the parameter for each corresponding character string, and a source code is generated. After step S403 is executed, the format shaping processing illustrated in FIG. 9 ends.

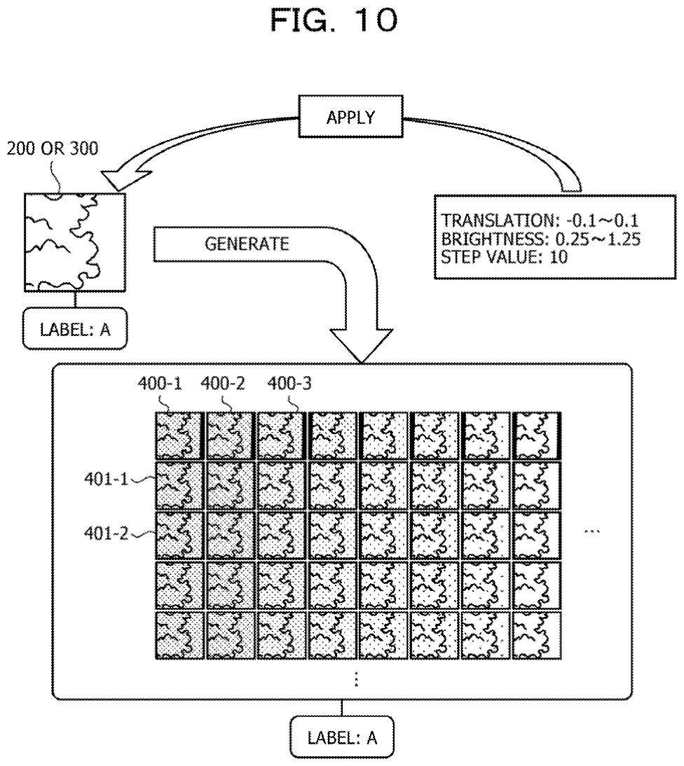

Then, input data to a machine learning model is generated according to the Data augmentation technique using the parameter range for each perturbation operation generated by executing the entire processing illustrated in FIG. 5. FIG. 10 is a diagram illustrating an example of machine learning data generation.

In the example in FIG. 10, it is assumed that perturbation operations estimated and generated by executing the entire processing illustrated in FIG. 5 be translation and brightness and a parameter range of the translation be of −0.1 to 0.1 and a parameter range of the brightness be of 0.25 to 1.25. Then, it is assumed that a Step value that is preset and used to divide parameter values be 10. Note that the number of types of perturbation operations, the parameter ranges of the respective perturbation operations, and the Step value are merely examples.

First, the determination device 10, for example, calculates a plurality of different parameters by dividing the parameter range of each perturbation operation by the Step value for each perturbation operation. In the example in FIG. 10, the Step value is 10. Therefore, 10 parameters are calculated for each of the translation and the brightness. Note that, in a case where the parameter is not divisible or the like, values are adjusted according to preset rules such as rounding up or rounding down.

Next, the determination device 10 applies combinations of the calculated parameters, that is, 100 combinations of 10 parameters for the translation*10 parameters for the brightness to an original image in the example in FIG. 10. Here, the original image is, for example, one of the still images 200 or the images 300 of the moving image that is the base of the perturbation operation estimation.

By applying the combinations of the parameters of each perturbation operation to the still image 200 or the image 300 that is the original image, as illustrated in FIG. 10, images 400-1, . . . , 401-1, . . . , 402-1, . . . to which the perturbation operation has been applied are generated. Note that a correct answer label of each image to which the perturbation operation has been applied is the same as that of the still image 200 or the image 300 that is the original image.

In this way, the determination device 10 generates the input data to the machine learning model, sets each of the generated images as a feature amount, and generates and trains a machine learning model using the feature amount and its correct answer label.

[Effects]

As described above, the determination device 10 specifies a difference between feature amounts of a plurality of first images that is captured in chronological order or of which the difference between the feature amounts is equal to or less than a threshold, refers to information in which the difference is associated with a data augmentation processing type, determines one or the plurality of data augmentation processing types used for processing of generating machine learning data on the basis of the specified difference between the feature amounts, and outputs a result of the determination processing.

The determination device 10 can estimate and select a perturbation operation with conditions close to an application domain for the image used for the input data to the machine learning model. Then, because the machine learning data is generated using the perturbation operation, the determination device 10 may further improve robustness of the machine learning model.

Furthermore, the determination device 10 further generates machine learning data using the result of the determination processing.

As a result, the determination device 10 may further improve the robustness of the machine learning model.

Furthermore, the determination device 10 further trains the machine learning model on the basis of the machine learning data generated using the result of the determination processing.

As a result, the determination device 10 may further improve the robustness of the machine learning model.

[System]

Pieces of information including a processing procedure, a control procedure, a specific name, various types of data, and parameters described above or illustrated in the drawings can be changed in any ways unless otherwise specified. Furthermore, the specific examples, distributions, numerical values, and the like described in the embodiments are merely examples, and can be changed in any ways.

Furthermore, each component of each device illustrated in the drawings is functionally conceptual and does not necessarily have to be physically configured as illustrated in the drawings. For example, specific forms of distribution and integration of each device are not limited to those illustrated in the drawings. For example, all or a part thereof can be configured by being functionally or physically distributed or integrated in optional units according to various types of loads, usage situations, or the like. Moreover, all or any part of individual processing functions performed in each device may be implemented by a central processing unit (CPU) and a program analyzed and executed by the CPU, or may be implemented as hardware by wired logic.

[Hardware]

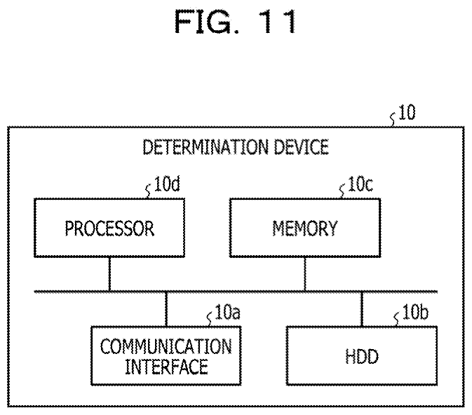

FIG. 11 is a diagram illustrating a hardware configuration example. As illustrated in FIG. 11 the determination device 10 includes a communication interface 10a, a hard disk drive (HDD) 10b, a memory 10c, and a processor 10d. Furthermore, the units illustrated in FIG. 11 are mutually connected by a bus or the like.

The communication interface 10a is a network interface card or the like and communicates with another server. The HDD 10b stores programs and databases for activating the functions illustrated in FIG. 2.

The processor 10d is a hardware circuit that reads a program that executes processing similar to the processing of each processing unit illustrated in FIG. 2 from the HDD 10b or the like, and develops the read program in the memory 10c, thereby activating a process that executes each function described with reference to FIG. 2 or the like. For example, this process executes a function similar to the function of each processing unit included in the determination device 10. For example, the processor 10d reads programs having functions similar to the image selection unit 31, the perturbation operation estimation unit 32, the format shaping unit 33, the Data augmentation unit 34, the machine learning model generation and training unit 35, or the like from the HDD 10b or the like. Then, the processor 10d executes a process for executing processing similar to the image selection unit 31, the perturbation operation estimation unit 32, the format shaping unit 33, the Data augmentation unit 34, the machine learning model generation and training unit 35, or the like.

In this way, the determination device 10 operates as an information processing device that executes operation control processing by reading and executing the program that executes similar processing to each processing unit illustrated in FIG. 2. Furthermore, the determination device 10 can also implement functions similar to the above-described examples by reading the program from a recording medium by a medium reading device and executing the read program. Note that the program referred to in other examples is not limited to being executed by the determination device 10. For example, the present embodiment can be similarly applied to a case where another computer or server executes the program, or a case where these cooperatively execute the program.

Furthermore, a program that executes similar processing to each processing unit illustrated in FIG. 2 can be distributed via a network such as the Internet. Furthermore, this program can be recorded in a computer-readable recording medium such as a hard disk, flexible disk (FD), compact disc read only memory (CD-ROM), magneto-optical disk (MO), or digital versatile disc (DVD), and can be executed by being read from the recording medium by a computer.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a determination program for causing a computer to execute processing comprising:
specifying a difference between feature amounts of a plurality of first images that is captured in chronological order or of which the difference between the feature amounts is equal to or less than a threshold;
referring to information in which the difference is associated with a data augmentation processing type and determining one or a plurality of data augmentation processing types used for processing of generating machine learning data on the basis of the specified difference between the feature amounts; and
outputting a result of the determination processing.

2. The non-transitory computer-readable recording medium storing the determination program according to claim 1 for causing the computer to execute processing further comprising:
generating machine learning data by using the result of the determination processing.

3. The non-transitory computer-readable recording medium storing the determination program according to claim 1 for causing the computer to execute processing further comprising:
training a machine learning model on the basis of the machine learning data generated by using the result of the determination processing.

4. A determination method comprising:
specifying, by a computer, a difference between feature amounts of a plurality of first images that is captured in chronological order or of which the difference between the feature amounts is equal to or less than a threshold;
referring to information in which the difference is associated with a data augmentation processing type and determining one or a plurality of data augmentation processing types used for processing of generating machine learning data on the basis of the specified difference between the feature amounts; and
outputting a result of the determination processing.

5. The determination method according to claim 4 further comprising:
generating machine learning data by using the result of the determination processing.

6. The determination method according to claim 4 further comprising:
training a machine learning model on the basis of the machine learning data generated by using the result of the determination processing.

7. An information processing device comprising:
a memory; and
a processor coupled to the memory and configured to:
specify a difference between feature amounts of a plurality of first images that is captured in chronological order or of which the difference between the feature amounts is equal to or less than a threshold;
refer to information in which the difference is associated with a data augmentation processing type and determining one or a plurality of data augmentation processing types used for processing of generating machine learning data on the basis of the specified difference between the feature amounts; and
output a result of the determination processing.

8. The information processing device according to claim 7, wherein the processor is configured to:
generate machine learning data by using the result of the determination processing.

9. The information processing device according to claim 7, wherein the processor is configured to:
train a machine learning model on the basis of the machine learning data generated by using the result of the determination processing.
